(19) United States
(12) Patent Application Publication
(10) Pub. No.: US 2025/0161973 A1
(43) Pub. Date: May 22, 2025

(54) MODULAR DELIVERY SYSTEM AND METHOD FOR AN ADHESIVE OR THERMOPLASTIC MATERIAL

(71) Applicant: Illinois Tool Works Inc., Glenview, IL (US)

(72) Inventors: Edward Wayne Bolyard, JR., Old Hickory, TN (US); Mel Steven Lessley, Villa Hills, KY (US)

(73) Assignee: Illinois Tool Works Inc., Glenview, IL (US)

(21) Appl. No.: 18/802,971

(22) Filed: Aug. 13, 2024

Related U.S. Application Data
(60) Provisional application No. 63/591,839, filed on Oct. 20, 2023.

(51) Int. Cl. B05C 11/10

(52) U.S. Cl. CPC B05C 11/1002; B05C 11/1042

(57) ABSTRACT

A modular system for delivering a fluid material is provided that may include a supply assembly for supplying a fluid material, a rate controlling assembly, and a pressure controlling assembly. The rate controlling assembly may be in fluid communication with the supply assembly and may vary a rate of a first portion of the fluid material supplied to a first applicator. The pressure controlling assembly may be in fluid communication with the supply assembly and may vary a pressure of a second portion of the fluid material supplied to a second applicator.

### CROSS-REFERENCE TO RELATED APPLICATIONS

This application claims priority to U.S. Provisional Application No. 63/591,839 (filed 20 Oct. 2023), the entire disclosure of which is incorporated herein by reference.

### BACKGROUND

### Technical Field

The subject matter described herein relates to hot melt adhesive or other thermoplastic material dispensing systems.

### Discussion of Art

In connection with the delivery of hot melt adhesive or other thermoplastic materials for use in implementing various or different hot melt adhesive or other thermoplastic material deposition or application procedures, conventional practices have dictated that depending upon particular application requirements or parameters, a particularly structured system be designed, manufactured, and installed. Different deposition or application procedures may require different structural systems to be designed, manufactured, purchased, and installed. For example, different deposition or application procedures may require differently sized hot melt adhesive or other thermoplastic material supply units or tanks. Alternatively, different deposition or application procedures, for example, different output material volume parameters or requirements, may dictate or require the use or employment of different hot melt adhesive or other thermoplastic material pump assemblies. Alternatively, different deposition or application procedures, for example, the minimalization of pressure losses, or the optimalization of pressure values, occurring within the various fluid flow lines or conduits comprising the entire hot melt adhesive or other thermoplastic delivery system, may dictate that the hot melt adhesive or other thermoplastic material pump assemblies and their applicators be disposed or located relatively close to the hot melt adhesive or other thermoplastic material supply units or tanks.

Spatial or logistic parameters characteristic of a particular plant or manufacturing facility, for example, the particular product manufacturing or production lines, may dictate that the hot melt adhesive or other thermoplastic material pump assemblies and their applicators be disposed or located remotely from the hot melt adhesive or other thermoplastic material supply units or tanks. Accordingly, if various hot melt adhesive or other thermoplastic material delivery systems are installed in a manufacturing facility in connection with various production lines implementing various hot melt adhesive or other thermoplastic material deposition or application procedures, it may be prohibitively expensive to incorporate such a variety of delivery systems within any one manufacturing plant or facility. Alternatively, while a particular delivery system could effectively be converted from one type of delivery system to another type of delivery system, again, the costs involved in connection with such conversion procedures could prevent the same from being economically viable.

A need therefore exists for a new and improved system for the delivery of hot melt adhesive or other thermoplastic materials, wherein the delivery system would be flexible and versatile as a result, for example, of the interchange or exchange of various components within the system. Such a system may permit various different deposition or application procedures to be readily achieved without the necessity of constructing or erecting a multitude of various different fixed or permanent delivery systems. In addition, there is also a need for a fluid control system whereby the separate fluids being supplied to the various pumps or applicator heads may be independently controlled so as to be characterized by different pressure parameters or values as required.

It may be desirable to have a system and method that differs from those that are currently available.

### BRIEF DESCRIPTION

In accordance with one example or aspect, a modular system for delivering a fluid material is provided that may include a supply assembly, a rate controlling assembly, and a pressure controlling assembly. The supply assembly may supply a fluid material. The rate controlling assembly may be in fluid communication with the supply assembly and may vary a rate of a first portion of the fluid material supplied to a first applicator. The pressure controlling assembly may be in fluid communication with the supply assembly and may vary a pressure of a second portion of the fluid material supplied to a second applicator.

In accordance with one example or aspect, a method is provided that may include supplying a fluid material from a supply assembly. The method may include varying a rate of a first portion of the fluid material supplied to a first applicator and varying a pressure of a second portion of the fluid material supplied to a second applicator. The method may include distributing the first portion of the fluid material via the first applicator and distributing the second portion of the fluid material via the second applicator.

In accordance with one example or aspect, a modular delivery system is provided that may include a supply assembly, a rate controlling assembly, a pressure relief device, a pressure controlling assembly, and a metering assembly. The supply assembly may supply a material. The rate controlling assembly may be in fluid communication with the supply assembly and may vary a rate of a first portion of the material supplied to a first applicator. The pressure relief device may be positioned between the rate controlling assembly and the first applicator. The pressure relief device may vary a pressure of the first portion of the material. The pressure controlling assembly may be in fluid communication with the supply assembly and may vary a pressure of a second portion of the material supplied to a second applicator. The metering assembly may be positioned between the pressure controlling assembly and the second applicator. The metering assembly may vary a rate of the second portion of the material.

### BRIEF DESCRIPTION OF THE DRAWINGS

The inventive subject matter may be understood from reading the following description of non-limiting embodiments, with reference to the attached drawings, wherein below:

FIG. 1 shows a perspective view of a modular system for delivering a material, according to one example;

FIG. 2 shows another perspective view of a modular system for delivering a material, according to one example;

FIG. 3 shows another perspective view of a modular system for delivering a material, with manifolds in an exploded position, according to one example;

FIG. 4 shows another perspective view of a modular system for delivering a material, with pumps in an exploded position, according to one example;

FIG. 5 shows another perspective view of a modular system for delivering a material, according to one example;

FIG. 6 shows another perspective view of a modular system for delivering a material, with manifolds in an exploded position, according to one example;

FIG. 7 shows another perspective view of a modular system for delivering a material, with components in an exploded position; and

FIG. 8 shows a method of delivering a material with a modular system, according to one example.

### DETAILED DESCRIPTION

One or more embodiments of the subject matter described herein relate to methods and systems for delivering an adhesive or other thermoplastic material to a dispensing system. The methods and systems may be a modular system for an adhesive melter. The adhesive melter may include one or more modular assemblies (e.g., swappable) for facilitating the delivery of the material. For example, the methods and systems may include a rate controlling assembly for varying a rate of a first portion of the material and may include a pressure controlling assembly for varying a pressure of a second portion of the material. The rate controlling assembly may apply a metered flow of material to applicator heads. The pressure controlling assembly may apply a pressurized flow of the material to the applicator heads.

It may be advantageous to be able to modify the modular assemblies based on the desired application for the delivery system. The modular assemblies may work together to provide the desired application outcome.

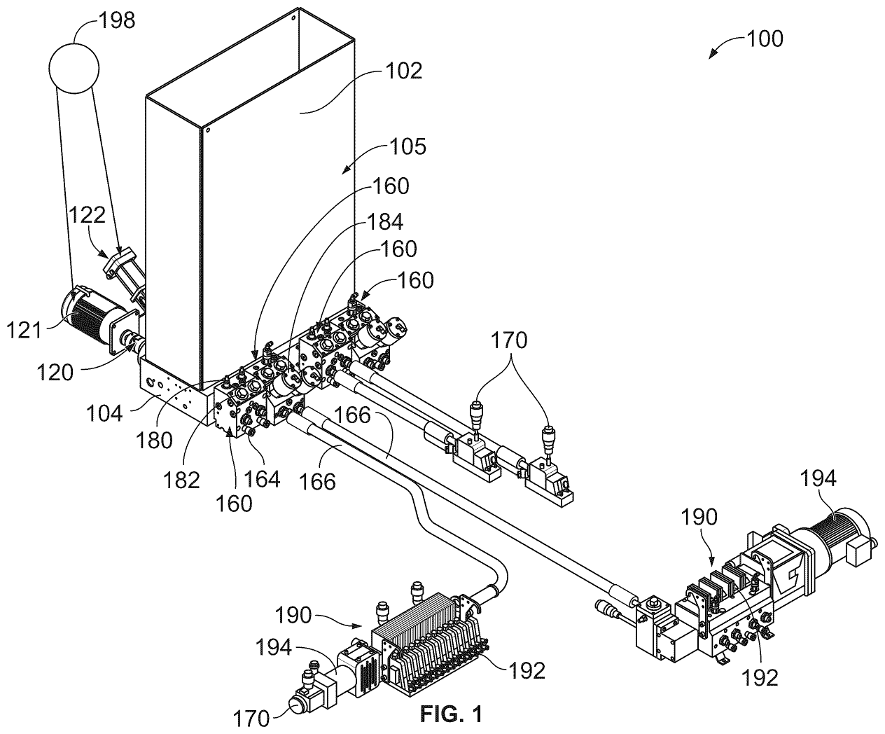

FIG. 1 shows a perspective view of a modular delivery system 100 for delivering a material, according to one example. The material may be a hot melt adhesive, another adhesive, a thermoplastic material, or another material. As used herein, material, hot melt adhesive, adhesive material, thermoplastic material, and the like may be used interchangeably. The modular system may include a supply tank assembly 102 within which a supply of the material may be stored. The material may be distributed via pumps 120, 122, manifolds 160, and conduits 166 to one or more applicator heads 170 or nozzles. In various embodiments, it may be useful to have different types of components, for example different pumps based on a desired distribution outcome. The selection and position of the pumps, manifolds, and conduits, may be modified on the supply tank assembly, creating the modular delivery system, as discussed further below.

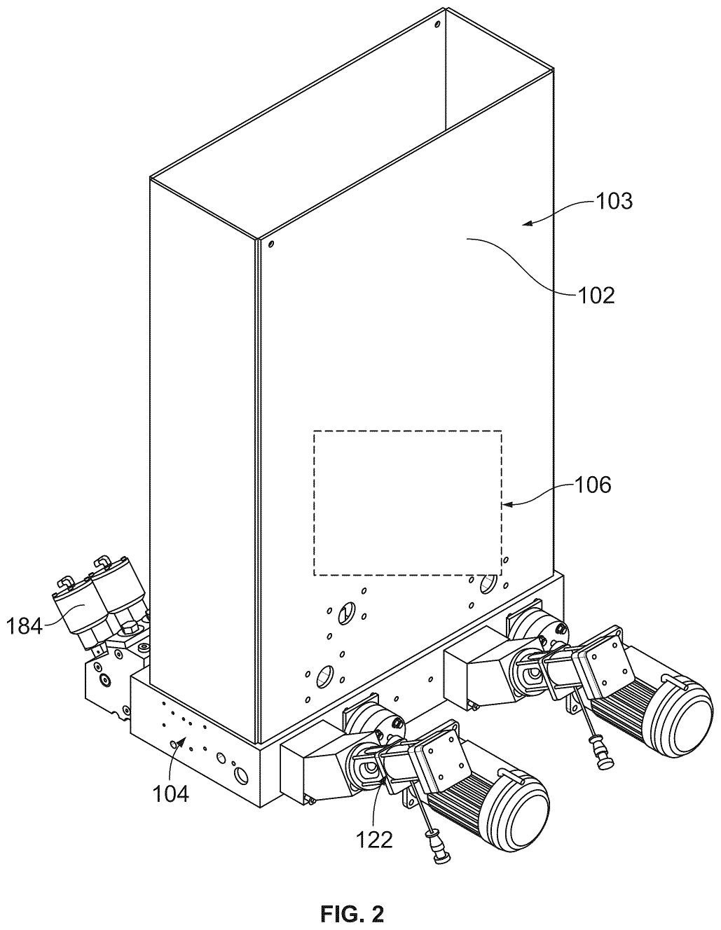

The supply tank assembly 102 may include a heating element 104 that may heat the material in the supply tank assembly. The heating element 104 may be a melter, for example a tank melter which may include a relatively large tank or hopper 106 (illustrated in FIG. 2) for storing molten adhesive material that is to be delivered as needed by dispensing devices. The heating element 104 or melter may receive the material in a solid or semi-solid form and then may heat and/or melt the material such that the material may be less viscous. By decreasing the viscosity, the flow of the material may be improved. The hopper 106 may maintain the heated material at a predetermined desired temperature level and viscosity.

The supply tank assembly 102, specifically the hopper 106, may provide a supply of the adhesive material to be provided to the applicator heads 170 or nozzles. However, gravity alone may not provide sufficient force to move the adhesive material from the supply tank assembly 102 to the applicator heads 170 or nozzles. As such, the modular delivery system may be provided with the one or more pumps 120, 122 fluidly coupled with the supply tank 102 and the hopper 106. The one or more pumps may drive the material to the applicator heads 170.

The pumps 120, 122 may receive the material from the hopper 106 via pump inlets 140. The material may enter the pump inlets 140 via conduits fluidly coupled with the supply tank assembly 102. The pumps 120, 122 may direct the material through pump outlets 150 to one or more manifolds 160. The material may enter the manifolds 160 via one or more conduits that fluidly couple the pumps 120, 122 and the manifolds 160. In one example, the conduits may be internal to the supply tank assembly 102, however, in another example the conduits may be external to the supply tank assembly 102.

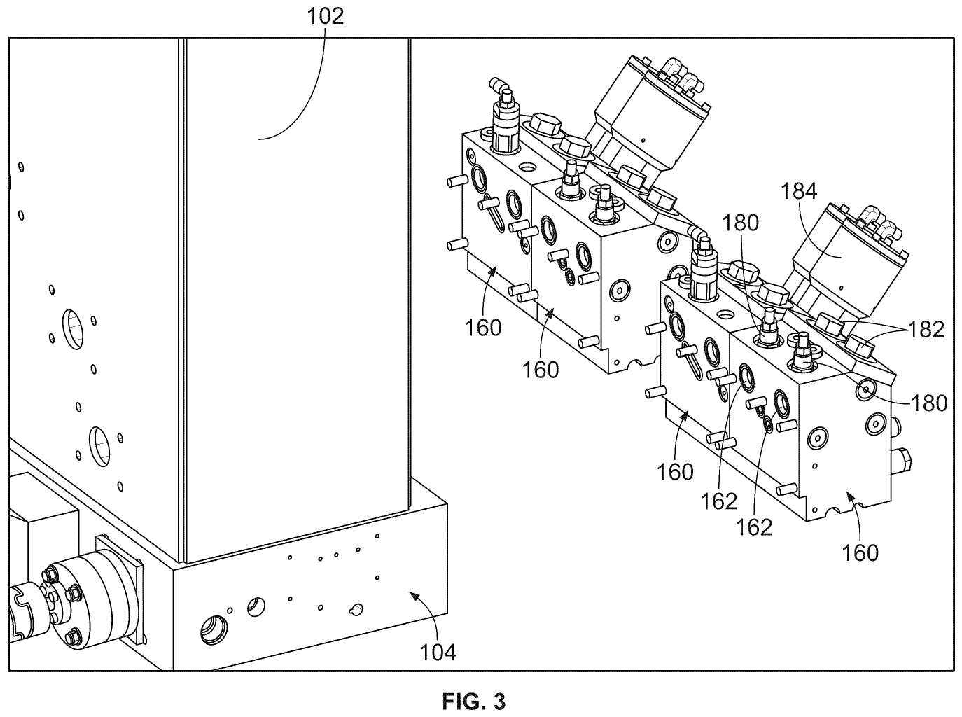

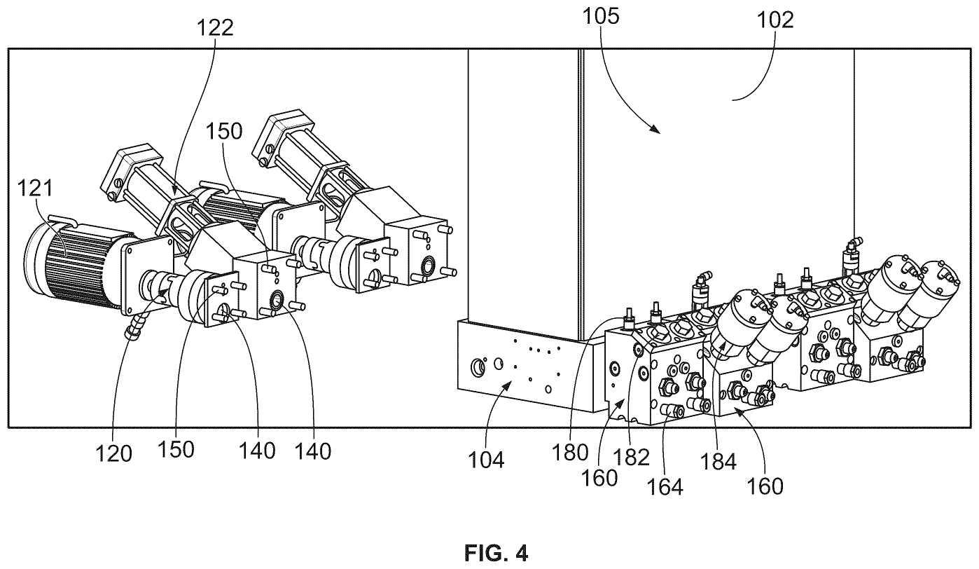

FIG. 3 illustrates the modular delivery system of FIG. 1, with the manifolds 160 shown in an exploded position. The manifolds 160 may receive the material from the pumps 120, 122 via manifold inlets 162. The manifold inlets 162 may be coupled to the pump outlets 150 via the one or more conduits. The manifolds 160 then may split the material into separate flows via internal conduits and may direct the flows to one or more manifold outlets 164. Each manifold outlet 164 may be associated with a different internal conduit. The manifold outlets 164 (shown in FIG. 4) may be coupled with hoses 166, for example heated hoses. The hoses 166 may then supply the material to the applicator heads 170 or nozzles to be dispensed to a distribution surface. FIG. 1 illustrates two hoses attached to a single manifold, however in other examples one hose may be attached to one manifold or more than two hoses may be attached to one manifold. Additionally, while FIG. 1 illustrates hoses attached to two of the four shown manifolds, in other examples hoses may be attached to all manifolds or to a different number of manifolds.

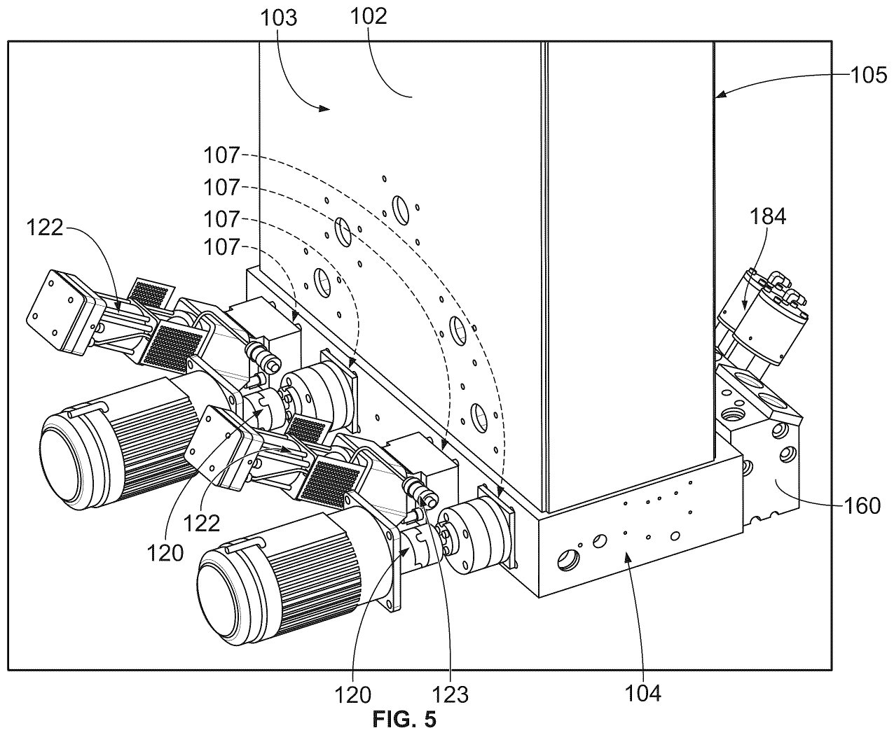

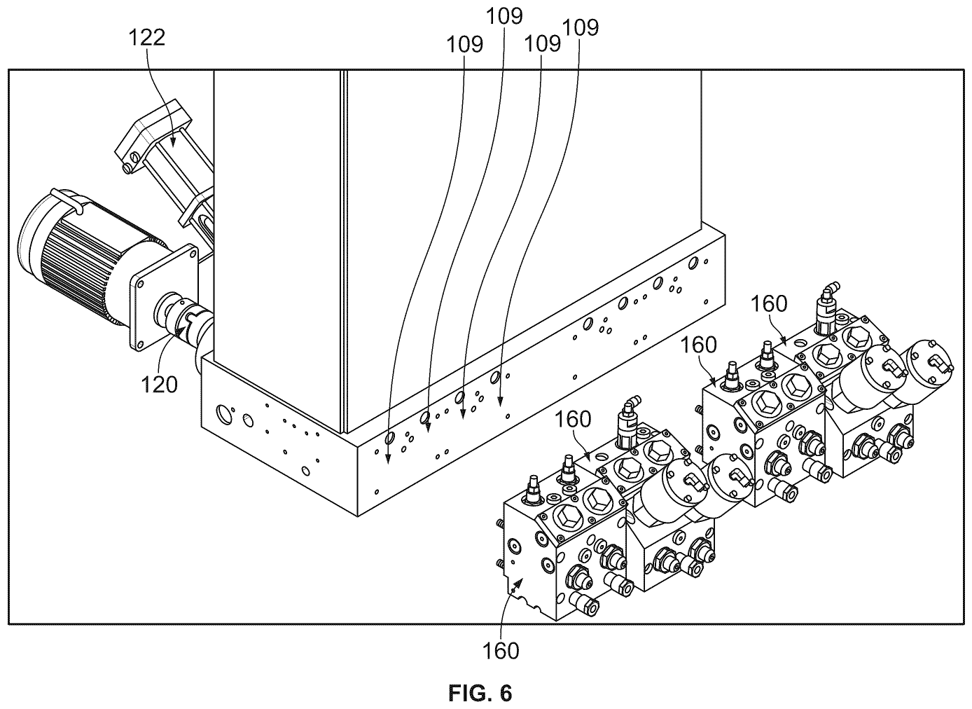

FIG. 5 illustrates another perspective view of the modular delivery system of FIG. 1. The supply tank assembly 102 may have a first side 103 and a second side 105. The first side 103 may include connection ports 107 that may receive and couple the one or more pumps 120, 122. FIG. 6 illustrates a perspective view of the modular delivery system of FIG. 1, with the manifolds shown in an exploded position. The second side 105 may include connection ports 109 that may receive and couple the one or more manifolds 160. In the illustrated examples, the first side 103 and the second side 105 may include four connection ports each. However, in other examples, the first side 103 and second side 105 may include more or less than four connection ports. Each connection port 107 on the first side 103 may be aligned and in fluid communication with one corresponding connection port 109 on the second side 105. The connection ports may include material inlets, air inlets, material outlets, air outlets, and a connection means. The connection means may be a friction fit, a mechanical fastener, a protrusion-detent arrangement, a snap fit, or the like. The connection ports may be designed such that a variety of pumps and manifolds may be interchangeably attached to the connection port depending on the desired adhesive material, distribution, and use.

The connection ports may facilitate the modularity, customizability, and interchangeability of the delivery system. By facilitating the customization of the components and the acceptance of different types of components, for example different types of pumps, the delivery system may reduce the cost to users as well as reduce the floor space that may need to be allocated for the delivery system. Instead of having a delivery system dedicated to each type of pump, the present delivery system may be able to have one delivery system that may receive and use multiple different pumps.

The arrangement of the pumps 120, 122 and the connection ports 107 may be selected and arranged based on desired distribution characteristics and/or material characteristics. The pumps 120, 122 may include a variety of different pumps, for example rate controlling pumps, pressure controlling pumps, and the like. The type of pump may be selected based on desired distribution characteristics. A rate controlling pump may control or modify a flow rate of the material passing through the pump. A pressure controlling pump may control a pressure of the material passing through the pump.

In one example, the rate controlling pumps may include a positive displacement pump 120, for example a gear box pump, a screw pump, a metering pump, a rotary piston pump, a progressive cavity pump, or the like. The positive displacement pump 120 may be coupled to the supply tank assembly 102 via the connection port 107. Where the pump is manually actuated, a motor 121 may be operatively coupled to the pump 120 to drive the pump. The positive displacement pump may receive a first portion of the material from the hopper 106 through the pump inlets 140. The rate of the first portion of the material may be varied by the positive displacement pump 120 before the material may be directed out the pump outlets 150 to the manifolds 160. In this way, the positive displacement pump 120 may be a part of a rate controlling assembly. The rate controlling assembly may vary the rate to a predetermined rate value.

The positive displacement pump 120 may allow a user to control the flow rate of the material that is supplied to the applicator heads 170. For example, the user may be able to input a desired flow rate, such as a number of grams or ounces of material to be distributed per second. The positive displacement pump 120 may be able to provide the desired flow rate based on the input. In one example, a control system or controller 198 (discussed further below) may select or input the desired flow rate. However, the positive displacement pump 120 may not be able to vary a pressure of the material.

The manifold 160 may include a pressure reducing assembly, for example one or more pressure relief devices 180. The pressure reducing assembly may be pneumatically operated, mechanically operated, manually operated, electrically operated, or the like. In one example, the pressure relief devices 180 may be check valves. The pressure relief devices 180 may be fluidly coupled downstream of the positive displacement pump 120 and upstream of the applicator heads 170. The pressure relief devices 180 may vary a pressure of the first portion of the material to a predetermined pressure before the material is supplied to the first applicator of the applicator heads 170. The pressure may be varied or reduced by selectively opening the pressure relief devices 180 to release pressure responsive to an internal pressure being above a predetermined threshold. Each pressure relief device 180 may be independently operated and adjustably controlled so that the adhesive material travelling through each manifold 160 may have a different working pressure value when delivered to the applicator heads 170. The pressure relief devices 180 may be controlled by air pressure, and therefore, the working pressure values may be proportional to the air pressure applied to each one of the pressure reducing devices 180. In one example, the pressure relief device may be controlled by a user input or by the controller 198.

In one example, the pressure controlling pumps may include one or more pressure pumps 122 that may pressurize the hot melt adhesive or other thermoplastic material received from the supply tank assembly 102 or the hopper 106. The pressure pump 122 may be a pneumatically actuated pressure pump. The connection ports 107 may be positioned and sized to couple the pressure pump 122 with the supply tank assembly 102. The pressure pump 122 may pressurize the material to a predetermined constant pressure value. An airline 123 may introduce air into the pressure pump and may drive a piston to build up pressure in the pressure pump 122.

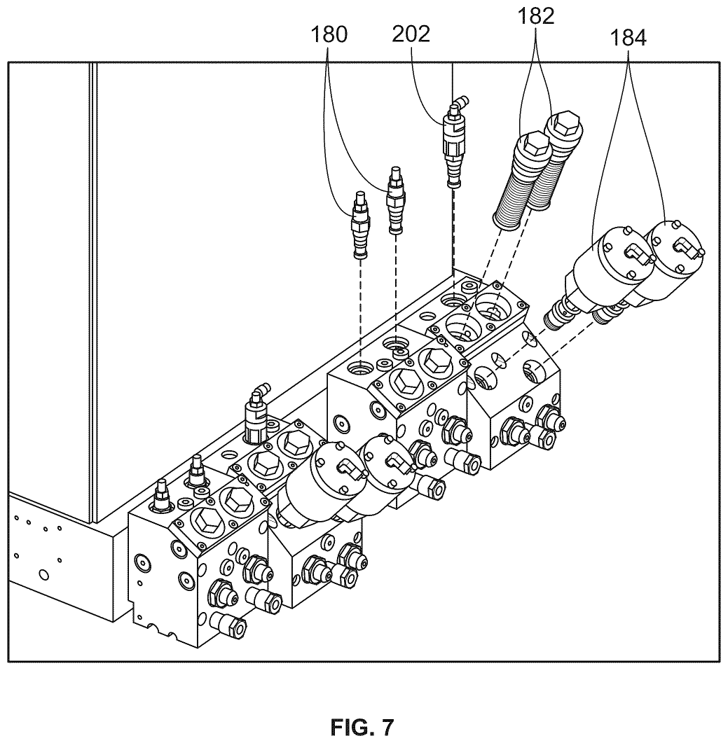

A manifold 160 may be fluidly coupled downstream of the pressure pump 122 and upstream of the applicator head 170. The manifold 160 may receive the pressurized material from the pressure pump 122 through the manifold inlet 162 and may direct the material to applicator head 170 via one or more manifold outlets 164. Additionally, the manifold 160 may include pressure controlling valves 184, shown in an exploded position in FIG. 7. The pressure controlling valves 184 may allow the pressure of the material in the manifold 160 to be further modified and controlled. The pressurized adhesive material may then be supplied from the manifold 160 to a second applicator of the applicator heads 170 at the predetermined constant pressure value. The pressure pump 122 may allow the user or control system to input a desired pressure output for the material. However, the pressure pump 122 may not allow the user or control system to input a desired flow rate of the material.

The modular delivery system may include one or more metering assemblies 190. The metering assemblies 190 may be fluidly coupled with the pressure pump 122. The metering assemblies 190 may be remote metering assemblies. The metering assemblies 190 may be positioned downstream of the pressure pump 122, downstream of the manifolds 160, and upstream of the second applicator 170. In one example, the metering assemblies 190 may be adjacent to the manifolds 160, however, the metering assemblies may be remote from the manifolds and the delivery system and may be coupled via conduits, for example the hoses 166. In one example, a metering assembly 190 may be positioned downstream of the positive displacement pump 120.

The metering assemblies 190 may include metering devices 192 and metering gear pumps 194 that may vary a rate of the second portion of the material before being supplied to the second applicator 170. The metering assemblies 190 may operate at a given speed to control the rate the material is distributed through the applicator heads 170. A predetermined or precisely metered amount of the adhesive material may be supplied from the metering assemblies 190 to the applicator heads. The metering assemblies 190 may allow for controlling or modifying the flow rate of the material from the pressure pump 122.

The positive displacement pump 120 and the pressure pump 122 may output the hot melt adhesive or other thermoplastic material to the pump outlets 150. The hot melt adhesive or other thermoplastic material may then pass through one or more filter 182 to remove unwanted or undesirable particles or impurities from the hot melt adhesive or other thermoplastic material. In one example, the filters 182 may be positioned within the pumps 120, 122. However, in the embodiment illustrated in FIG. 7, the filters 182 may be positioned within the manifolds 160. After passing through the filter 182, the hot melt adhesive or other thermoplastic material may enter the hoses 166 and pass through to the applicator heads 170. In one example, the filters 182 may be positioned downstream of the pumps 120, 122 and upstream of the applicator heads 170. The filters 182 may be mounted on the supply tank 102 and may filter the adhesive material received from the pumps 120, 122 before supplying the filtered adhesive material to the applicator heads 170. In one example, the filters 182 may be mounted on, or integral with, the manifolds 160. The filters 182 may be removable for cleaning, maintenance, and/or replacement.

While the embodiment illustrated in FIG. 5 illustrates alternating positive displacement pumps 120 and pressure pumps 122 coupled to the supply tank assembly 102, the modular delivery system may be arranged differently in other embodiments. As discussed, the connection ports 107 may receive and couple either the positive displacement pumps 120 or the pressure pumps 122. As such, in one example there may be two consecutive positive displacement pumps 120 followed by two consecutive pressure pumps 122. In another example, there may be three positive displacement pumps 120 and one pressure pump 122. Further, there may be additional connection ports 107 such that the modular delivery system may have more than four pumps. The selection and arrangement of the pumps 120, 122 may be customized based on the desired distribution of the material. The system may include adapters that may selectively couple a particular pump (e.g., 120 or 122) with the connection ports 107. The adapters may allow further customization and modularization. In one example, an adapter face may be designed such that a first side of the adapter face may be couplable with the connection port 107 and a second side of the adapter face may be couplable with one of pump 120 or pump 122. The delivery system may be completely modular and adjustable to meet desired distribution rate and pressure.

In one example, the modular delivery system may include a controller 198. The controller may include microcontrollers, processors, microprocessors, or other logic devices that operate based on instructions stored on a tangible and non-transitory computer readable storage medium, such as software applications stored on a memory. The controller may communicate control signals to the pumps 120, 122. The control signals may control or modify the rate of the first portion of the material going through the positive displacement pump 120. The control signals may control or modify the pressure of the second portion of the material going through the pressure pump 122.

If a system, apparatus, assembly, device, etc. (e.g., a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

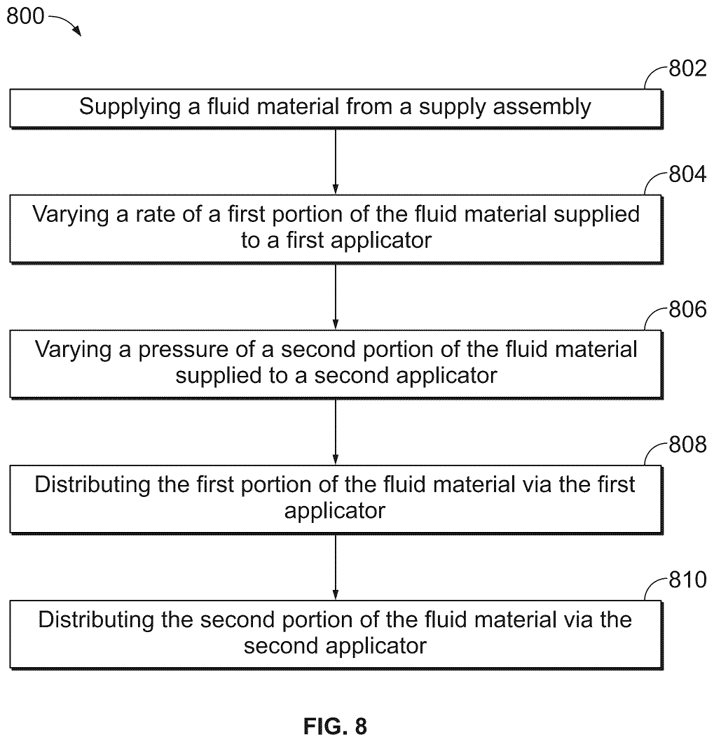

FIG. 8 shows a method of delivering a material with a modular system, according to one example. The material may be a hot melt adhesive, another adhesive, a thermoplastic material, or another material. The modular system may include a supply tank assembly within which a supply of the material may be stored. The supply tank assembly may include a heating element that may heat the material in the supply tank. The heating element may be a melter, for example a tank melter which may include a relatively large tank or hopper for storing molten adhesive that is to be delivered as needed by dispensing devices. The supply tank assembly may include one or more pumps that may direct the material from the supply tank assembly to applicator heads to deliver the material. The pumps may include a combination of rate controlling pumps and pressure controlling pumps.

At step 802, the method may include supplying a fluid material from the supply assembly. As discussed above, the material may be liquified by the melter and stored in the hopper. The supply assembly may include the hopper.

At step 804, the method may include varying a rate of a first portion of the fluid material supplied to a first applicator. The rate of the first portion of the fluid material may be modified or controlled by a rate controlling pump, for example a positive displacement pump.

At step 806, the method may include varying a pressure of a second portion of the fluid material supplied to a second applicator. The pressure of the second portion of the fluid material may be modified or controlled by a pressure controlling pump, for example a pressure pump.

At step 808, the method may include distributing the first portion of the fluid material via the first applicator. The first portion of the fluid material may be driven by the rate controlling pump to arrive at a predetermined rate at the first applicator. In one example, the method may include varying a pressure of the first portion of the fluid material via pressure relief devices. The pressure relief devices may be fluidly coupled downstream of the positive displacement pump and upstream of the first applicator. The pressure relief devices may vary the pressure of the first portion of the fluid material to a predetermined pressure before the material is supplied to the first applicator.

At step 810, the method may include distributing the second portion of the fluid material via the second applicator. The second portion of the fluid material may be driven by the pressure controlling pump to arrive at a predetermined pressure at the second applicator. In one example, the method may include metering assemblies that may be fluidly coupled with the pressure controlling pump. The metering assemblies may be positioned downstream of the pressure controlling pump and upstream of the second applicator. The metering assemblies may include metering devices and metering gear pumps that may vary the rate of the second portion of the fluid material before being supplied to the second applicator.

The applicators or applicator heads may deliver the fluid material (e.g., a hot melt adhesive) onto one or more surfaces of products, such as absorbent hygiene products. These types of products can include incontinence products, diapers, or the like. For example, the hot melt adhesive may be used to glue elastic bands to the products.

In one embodiment, a modular system for delivering a fluid material is provided that may include a supply assembly, a rate controlling assembly, and a pressure controlling assembly. The supply assembly may supply a fluid material. The rate controlling assembly may be in fluid communication with the supply assembly and may vary a rate of a first portion of the fluid material supplied to a first applicator. The pressure controlling assembly may be in fluid communication with the supply assembly and may vary a pressure of a second portion of the fluid material supplied to a second applicator.

In one example, the rate controlling assembly may include a gear pump. The first portion of the fluid material may enter a pressure relief device that may vary a pressure of the first portion of the fluid material before being supplied to the first applicator. The second portion of the fluid material may enter a metering device that may vary a rate of the second portion of the fluid material before being supplied to the second applicator.

The modular system for delivering the fluid may include one or more filters positioned between the rate controlling assembly and the first applicator. The system may include one or more filters positioned between the pressure controlling assembly and the second applicator. The fluid material may be a thermoplastic. In one example, a controller is provided that may one or more of control the rate of the first portion of the fluid material or control the pressure of the second portion of the fluid material.

In one embodiment, a method is provided that may include supplying a fluid material from a supply assembly. The method may include varying a rate of a first portion of the fluid material supplied to a first applicator and varying a pressure of a second portion of the fluid material supplied to a second applicator. The method may include distributing the first portion of the fluid material via the first applicator and distributing the second portion of the fluid material via the second applicator.

In one example, the method may include varying a pressure of the first portion of the fluid material after varying the rate of the first portion of the fluid material. The method may include varying a rate of the second portion of the fluid material after varying the pressure of the second portion of the fluid material.

In one example, the method may include filtering the first portion of the fluid material before the first portion of the fluid material is supplied to the first applicator. The method may include filtering the second portion of the fluid material before the second portion of the fluid material is supplied to the second applicator. The method may include providing a controller for controlling one or more of control the rate of the first portion of the fluid material or the pressure of the second portion of the fluid material.

In one embodiment, a modular delivery system is provided that may include a supply assembly, a rate controlling assembly, a pressure relief device, a pressure controlling assembly, and a metering assembly. The supply assembly may supply a material. The rate controlling assembly may be in fluid communication with the supply assembly and may vary a rate of a first portion of the material supplied to a first applicator. The pressure relief device may be positioned between the rate controlling assembly and the first applicator. The pressure relief device may vary a pressure of the first portion of the material. The pressure controlling assembly may be in fluid communication with the supply assembly and may vary a pressure of a second portion of the material supplied to a second applicator. The metering assembly may be positioned between the pressure controlling assembly and the second applicator. The metering assembly may vary a rate of the second portion of the material.

In one example, the supply assembly may include a heating assembly to heat the material to a liquid state. The modular delivery system may include one or more filters positioned between the rate controlling assembly and the first applicator. The modular delivery system may include one or more filters positioned between the pressure controlling assembly and the second applicator.

In one example, the modular delivery system may include a controller that may one or more of control the rate of the first portion of the material or control the pressure of the second portion of the material. The material may be a thermoplastic material.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A modular system for delivering a fluid material, the modular system comprising:
a supply assembly configured to supply a fluid material;
a rate controlling assembly in fluid communication with the supply assembly, the rate controlling assembly configured to vary a first rate of a first portion of the fluid material supplied to a first applicator; and
a pressure controlling assembly in fluid communication with the supply assembly, the pressure controlling assembly configured to vary a first pressure of a second portion of the fluid material supplied to a second applicator.

2. The modular system of claim 1, wherein the rate controlling assembly includes a gear pump.

3. The modular system of claim 1, further comprising:
a pressure relief device configured to receive the first portion of the fluid material from the rate controlling assembly, the pressure relief device configured to reduce a second pressure of the first portion of the fluid material before the first portion of the fluid material is supplied to the first applicator.

4. The modular system of claim 1, further comprising:
a metering device configured to receive the second portion of the fluid material from the pressure controlling assembly, the metering device configured to vary a second rate of the second portion of the fluid material before the second portion of the fluid material is supplied to the second applicator.

5. The modular system of claim 1, further comprising:
one or more filters positioned between the rate controlling assembly and the first applicator for the first portion of the fluid material to pass through from the rate controlling assembly to the first applicator.

6. The modular system of claim 1, further comprising:
one or more filters positioned between the pressure controlling assembly and the second applicator for the second portion of the fluid material to pass through from the pressure controlling assembly to the second applicator.

7. The modular system of claim 1, wherein the fluid material is a thermoplastic adhesive.

8. The modular system of claim 1, further comprising:
a controller configured to control the first rate of the first portion of the fluid material using the rate controlling assembly and control the first pressure of the second portion of the fluid material using the pressure controlling assembly.

9. A method comprising:
supplying a fluid material from a supply assembly;
varying a first rate of a first portion of the fluid material supplied to a first applicator;
varying a first pressure of a second portion of the fluid material supplied to a second applicator;
distributing the first portion of the fluid material via the first applicator; and
distributing the second portion of the fluid material via the second applicator.

10. The method of claim 9, further comprising:
varying a second pressure of the first portion of the fluid material after varying the first rate of the first portion of the fluid material.

11. The method of claim 9, further comprising:
varying a second rate of the second portion of the fluid material after varying the first pressure of the second portion of the fluid material.

12. The method of claim 9, further comprising:
filtering the first portion of the fluid material before the first portion of the fluid material is supplied to the first applicator.

13. The method of claim 9, further comprising:
filtering the second portion of the fluid material before the second portion of the fluid material is supplied to the second applicator.

14. A modular delivery system, comprising:
a supply assembly configured to supply a fluid adhesive;
a rate controlling assembly in fluid communication with the supply assembly, the rate controlling assembly configured to receive a first portion of the fluid adhesive and vary a first rate of a first portion of the fluid adhesive;
a pressure relief device positioned to receive the first portion of the fluid adhesive from the rate controlling assembly, the pressure relief device configured to vary a first pressure of the first portion of the fluid adhesive;
a pressure controlling assembly in fluid communication with the supply assembly, the pressure controlling assembly configured to receive a second portion of the fluid adhesive from the supply assembly and vary a second pressure of the second portion of the fluid adhesive; and
a metering assembly positioned to receive the second portion of the fluid adhesive and vary a second rate of the second portion of the fluid adhesive.

15. The modular delivery system of claim 14, wherein the pressure controlling assembly is configured to be removed and replaced with the metering assembly, and the metering assembly is configured to be removed and replaced with the pressure controlling assembly.

16. The modular delivery system of claim 14, wherein the supply assembly includes a heating assembly configured to heat pellets of adhesive into the fluid adhesive.

17. The modular delivery system of claim 14, further comprising:
one or more filters positioned between the rate controlling assembly and a first applicator that applies the fluid adhesive to a product surface.

18. The modular delivery system of claim 14, further comprising:
one or more filters positioned between the pressure controlling assembly and a second applicator that applies the fluid adhesive to a product surface.

19. The modular delivery system of claim 14, further comprising:
a controller configured to one or more of control the first rate of the first portion of the fluid adhesive or control the first pressure of the second portion of the fluid adhesive.

20. The modular delivery system of claim 14, wherein the fluid adhesive is thermoplastic.
